(19) United States
(12) Patent Application Publication
(10) Pub. No.: US 2007/0064347 A1
(43) Pub. Date: Mar. 22, 2007

(54) MICROACTUATOR, HEAD GIMBAL ASSEMBLY AND HARD DISK DRIVE USING THE SAME, AND METHOD OF MANUFACTURING MICROACTUATOR

(75) Inventor: Takashi HONDA, Hong Kong (HK)

Correspondence Address: GREENBLUM & BERNSTEIN, P.L.C., 1950 ROLAND CLARKE PLACE, RESTON, VA, 20191, US

(73) Assignee: SAE MAGNETICS (H.K.) LTD., Hong Kong (HK)

(21) Appl. No.: 11/532,208

(22) Filed: Sep. 15, 2006

(30) Foreign Application Priority Data
Sep. 22, 2005 (JP) 2005-276602

(51) Int. Cl. G11B 5/56

(52) U.S. Cl. 360/294.4

(57) ABSTRACT

A microactuator includes: a base part to be joined to a flexure; a pair of arms, joined to the base part, for holding a magnetic head slider therebetween; and a PZT device, mounted on each of the arms, to be deformed in an expanding or contracting manner based on a drive signal applied. Each of the arms is provided with a support part for supporting a surface opposite to an ABS forming surface of the magnetic head slider.

### BACKGROUND OF THE INVENTION

1. Field of the Invention

The present invention relates to a microactuator, and in particular, to an actuator for precisely positioning a magnetic head slider mounted thereon. Further, the present invention relates to a head gimbal assembly and a hard disk drive using the actuator. Moreover, the present invention relates to a method of manufacturing a microactuator.

2. Description of the Related Art

A hard disk drive, which is a data storage, is provided with a head gimbal assembly on which a magnetic head slider or reading and writing data from/into a magnetic disk, or a storage medium, is mounted. A conventional example of a head gimbal assembly will be described below.

A head gimbal assembly (not shown) includes: a magnetic head slider 101; a flexure having a spring property in which the magnetic head slider 101 is mounted on the tip part thereof; an FPC (flexible printed circuit) formed on the flexure for transmitting signals to the magnetic head slider; and a load beam supporting the flexure. The load beam is mounted on a head arm via a base plate. Further, a plurality of head gimbal assemblies are stacked and fixed to a carriage via respective head arms and pivotally supported so as to be driven rotationally by a voice coil motor to thereby constitute a head stack assembly.

The head gimbal assembly 100 is driven rotationally by the voice coil motor to thereby position the magnetic head slider mounted on the tip part thereof. In recent years, however, due to an increase in recording density of a magnetic disk, positioning accuracy of a magnetic disk provided by such a control is not sufficient.

In view of the above, techniques for more precise positioning have been considered. In example thereof is disclosed in Japanese Patent Laid-Open Publication No. 2002-74870 (Patent Document 1). The configuration of a conventional magnetic head actuator mounted on a head gimbal assembly will be described below with reference to FIGS. 1A and 1B.

As shown in Patens Document 1, a magnetic head actuator 110 is mounted on a tongue plane of a flexure. The actuator is formed in an almost U-shape, and holds the magnetic head slider 101 such that the read/write element is positioned at the opening end side. In more detail, the magnetic head actuator 110 is formed in an almost U-shape, including a base part 111 to be mounted on she flexure and a pair of arms 112 and 113 joined to the base part 111 so as to extend in the same direction from the both edges of the base part 111, and a space is defined between the pair of arms 112 and 113. In the space, the magnetic head slider 101 is accommodated and held as described later. Note that the base part 111, and the pair of arms 112 and 113 are integrally formed of a ceramic sintered body having elasticity.

By the actuator 110 of the above-described configuration, the magnetic head slider 101 is held such that the side faces near the tip thereof are fixed with an adhesive 114 such as epoxy resin applied so the inner sides near the tip parts of the respective arms 112 and 113. In other words, the magnetic head slider 101 is held between the arms 112 and 113 from she sides thereof.

On the outer side faces of the respective arms 112 and 113, piezoelectric devices 112a and 113b such as PZT are mounted (not shown in FIG. 1B), respectively. The piezoelectric devices 112a and 113b expand or contract when a voltage is applied. Thereby, the elastic arms 112 and 113 are to be deformed in a bending manner almost along the magnetic disk surface. Accordingly, it is possible to swing-drive the read/write element of the magnetic head slider 101 mounted on the tip parts of the pair of arms 112 and 113 almost along the magnetic disk surfaces whereby precise positioning control can be performed.

In the example shown in FIG. 1B, a magnetic disk will be positioned above the magnetic head slider 101 so as to face it, so a read/write element (not shown) is formed on a surface facing the magnetic disk (upper surface) of the tip side of the magnetic head slider 101, and a read/write element side terminal is formed on the end face of the tip side thereof (left end face) (not shown). In FIG. 1B, the magnetic head slider 101 is arranged and held between the arms 112 and 113 at a position higher than the top surfaces of the arms 112 and 113 so as to make the read/write element of the magnetic head slider 101 closer to a magnetic disk. In other words, the lower surface of the magnetic head slider 101 is arranged and held at a position above the lower surfaces of the arms 112 and 113.

[Patent Document 1] JP2002-74870A

However, the conventional magnetic head actuator 110 described above is just held in such a manner that the side faces of the magnetic head slider 101, accommodated between the arms 112 and 113, are fixed with the adhesive 114. This causes a problem in the holding stability. For example, when a shock is applied in a height direction of the arms 112 and 113, the holding strength by the actuator 110 is weak, so the magnetic head slider 101 may be displaced or dropped.

Further, there is a case where the magnetic head slider 101 is mounted above she bottom surfaces of the arms 112 and 113 in order to make the magnetic head element close to a disk or because of its size as described above. Therefore, if only the side faces of she magnetic head slider are held as described above, a problem that appropriate positioning at the time of mounting being difficult has been caused.

### SUMMARY OF THE INVENTION

It is therefore an object of the present invention to provide a microactuator capable of solving disadvantages involved in the above-described conventional example, and in particular, improving the positioning accuracy in mounting a magnetic head slider and improving the reliability.

In order to achieve the object, a microactuator, which is one mode of the present invention, is a microactuator comprising: a base part to be joined to a flexure; a pair of arms, joined to the base part, for holding a magnetic head slider therebetween; and a PZT device, mounted on each of the arms, to be deformed in an expanding or contracting manner based on a drive signal applied. Each of the arms is provided with a support part for supporting a surface opposite to the ABS forming surface of the magnetic head slider.

According to the invention mentioned above, the magnetic head slider is so supported that the side faces thereof are held between the arms of the microactuator and a surface perpendicular to the thickness direction, that is, a surface opposite to the ABS forming surface, is supported by the support parts. Accordingly, positioning of the magnetic head slider with respect to the microactuator at the time of mounting becomes easy, whereby it is possible to realize highly accurate positioning operation of the magnetic head slider. Further, it is possible to improve the intensity and stability when the magnetic head slider is held by the microactuator.

The support part is formed as a protrusion protruding from each of the arms. Thereby, the magnetic head slider can be supported by a simple configuration.

Further the support part has a flat part for supporting the magnetic head slider. Thereby, the magnetic head slider can be placed on the flat surfaces of the protrusions, which enables more stable support.

Further, the support part is provided near the tip part of the arm on a side opposite to the base part. Thereby, the support parts of the actuator can support the read/write element side of the magnetic heals slider. This enables to support more stably and to improve the read/write accuracy.

A head gimbal assembly, which is another mode of the present invention, comprises: a suspension having a flexure; the microactuator described above to be joined to the flexure; and a magnetic head slider supported by the support parts of the microactuator and held between the pair of arms.

The support part is applied wish an adhesive for fixing the magnetic head slider. Thereby, the joining strength between the actuator and the magnetic head slider increases, so it is possible to further improve the stability of the support.

Furthers in the head gimbal assembly, the magnetic head slider is mounted so as to protrude from the tip parts of the arms of the microactuator.

Further, the present invention provides a method of manufacturing a head gimbal assembly, comprising the steps of: placing and positioning a magnetic head slider on support parts of a microactuator; and holding the magnetic head slider between a pair of arms.

Further, the present invention also provides a hard disk drive in which the head gimbal assembly described above is mounted.

Thereby, when assembling the magnetic head slider into the actuator, the positioning thereof becomes easy as described above, so assembling accuracy can be improved, and a head gimbal assembly excellent in anti-shock property can be configured. Further, the reliability of the hard disk drive on which the head gimbal assembly is mounted can be improved. In particular, by mounting the magnetic head slider to protrude from the arms of the actuator, it is possible to expand the swing range and to support the part near the center of the magnetic head slider by the support paints mentioned above. This leads to an improvement in stability.

Further, a method of manufacturing a microactuator, which is another mode of the present invention, comprises the steps of: stacking one or more base plates constituting a base part to be joined to a flexure by inserting them in between a pair of arm plates constituting a pair of arms joined to the base part (stacking step); before or after the stacking step, forming a PZT device, mounted on each of the arms, to be deformed in an expanding or contracting manner based on a drive signal applied, on the outer surface of each of the arm plates (PZT element forming step); and cutting the layer member layered in the stacking step along a stacking direction so as to cut out an microactuator holding side faces of a magnetic head slider between the pair of arms (cutting step). In the stacking step, a support part plate forming a support part for supporting a flat surface perpendicular to the thickness direction of the magnetic head slider held between the arms, is inserted between the arm plate and the base plate.

In the cutting step, the height of the support part along the height direction of the arm is set, and then the microactuator is cut out.

In particular, in the method of manufacturing a microactuator, it is desirable to manufacture the microactuator described above.

Thereby, by cutting out from the layer member in which a plurality of plates are stacked, it is possible to easily manufacture a microactuator having support parts (protrusions) for supporting a magnetic head slider. This enables to simplify the manufacturing process and to reduce the manufacturing cost.

### EFFECT OF THE INVENTION

The present invention is configured and works as described above. Thereby, positioning of she magnetic head slider with respect to the microactuator at the time of mounting becomes easy, and the mounting accuracy of the magnetic head slider is improved, so highly accurate positioning operation of the magnetic head slider by the microactuator can be realized. Accordingly, the manufacturing process is simplified, and the read/write accuracy of the hard disk drive using it is improved. Further, it is possible to improve the strength when the magnetic head slider is held by the microactuator. This enables to improve the anti-shock property of the hard disk drive equipped with it, and to improve the reliability.

### BRIEF DESCRIPTION OF THE DRAWINGS

FIG. 1A is a top view showing the configuration of an actuator of a conventional example;

FIG. 1B is a side view of FIG. 1A;

FIG. 2 is a diagram showing the configuration of a hard disk drive;

FIG. 3 is a diagram showing the configuration of a head gimbal assembly;

FIG. 4A is a perspective view showing the configuration of an actuator holding a magnetic head slider;

FIG. 4B is a front view of FIG. 4A;

FIG. 5A is a perspective view showing the configuration when the magnetic head slider is mounted on the actuator;

FIG. 5B is a perspective view of FIG. 5A seen from the back side;

FIG. 6 is a top view showing a state where the actuator is mounted on a flexure;

FIG. 7 is a side view of FIG. 6;

FIG. 8 is a diagram showing the configuration of a layer member; FIG. 9A is a partial enlarged view of a protrusion plate disclosed in FIG. 8;

FIG. 9B is a partial enlarged view snowing a base plate disclosed in FIG. 8;

FIG. 9C is a diagram explaining a cut part of the layer member disclosed in FIG. 8;

FIG. 10 is a diagram showing the configuration of the layer member;

FIG. 11 is a diagram showing the configuration of a bar member cut out from the layer member shown in FIG. 10;

FIG. 15A is a partial enlarged view of the bar member disclosed in FIG. 11;

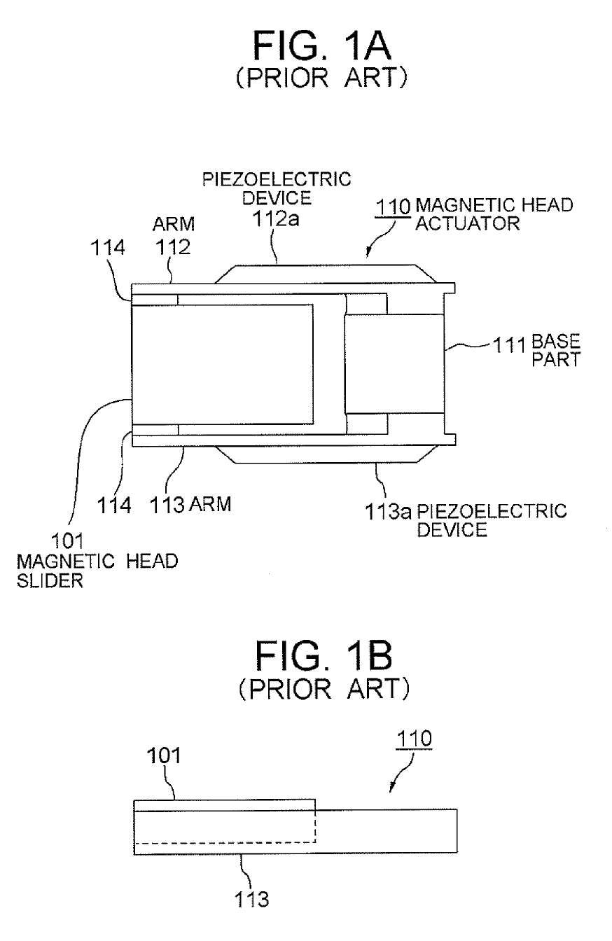

FIG. 12B is a diagram explaining cut parts when an actuator is cut out from the bar member;

FIG. 13 is a diagram showing a state in which actuators are cut out from the bar member; and

FIG. 14 is a flowchart showing the manufacturing procedures of an actuator.

### DESCRIPTION OF THE PREFERRED EMBODIMENTS

A microactuator of the present invention is characterized in that arms are provided with support parts for supporting parts other than side faces of a magnetic head slider. Hereinafter, specific configuration and operation of the microactuator and its manufacturing method will be described by way of embodiments.

### Embodiment 1

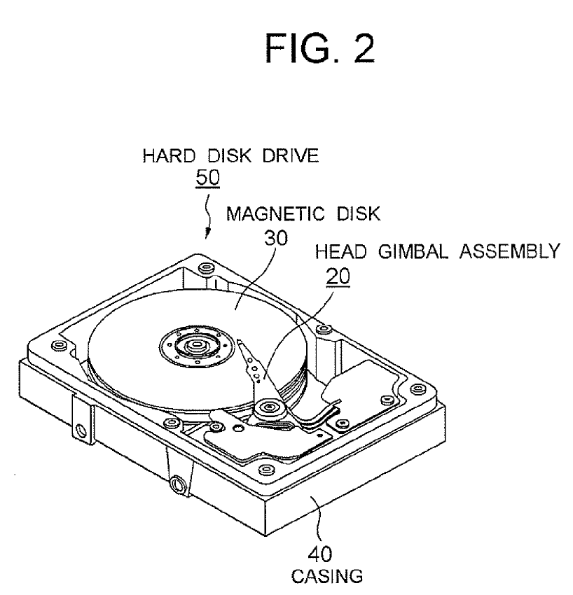

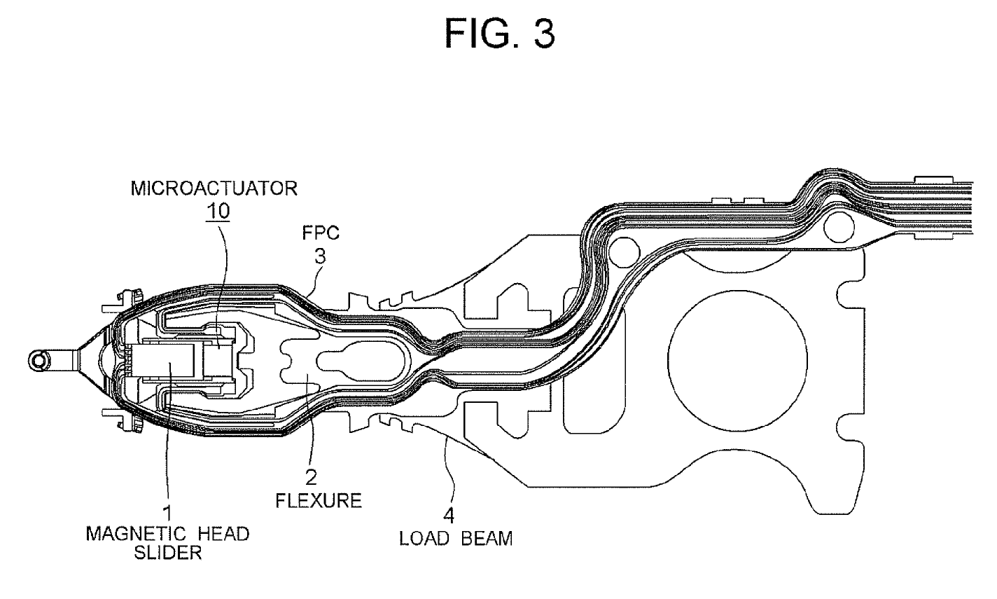

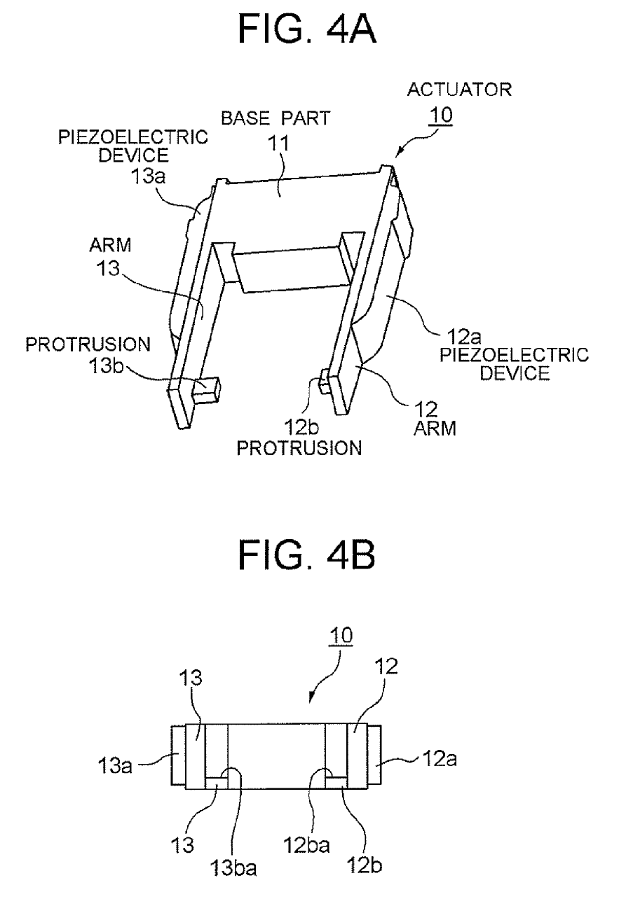

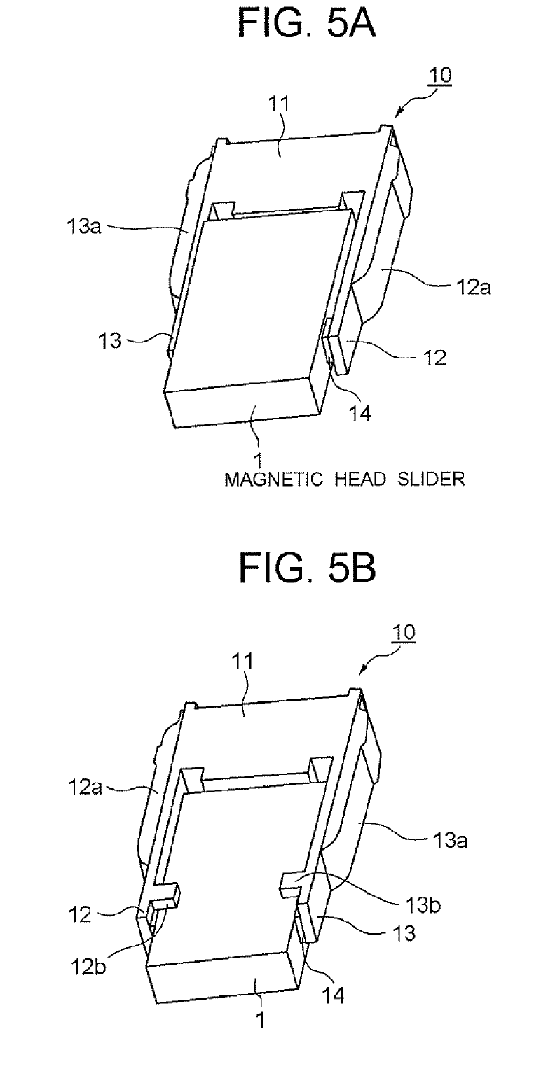

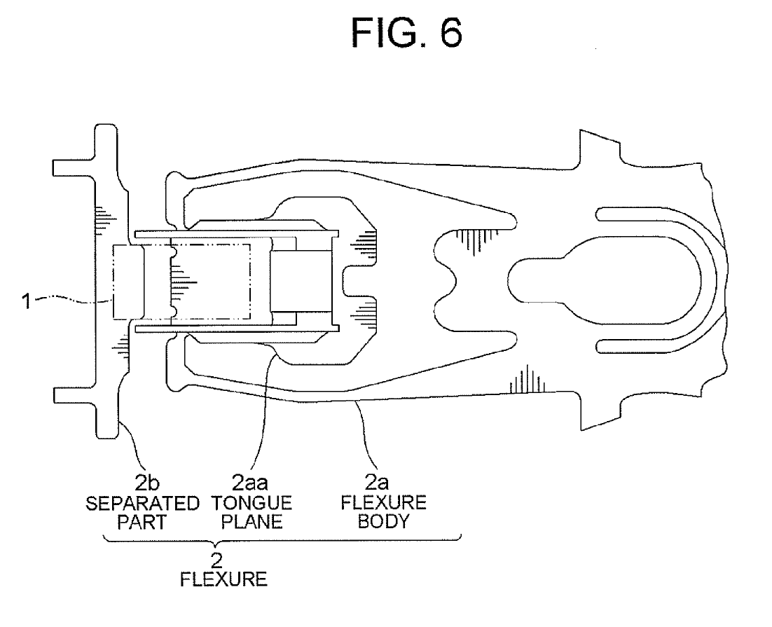

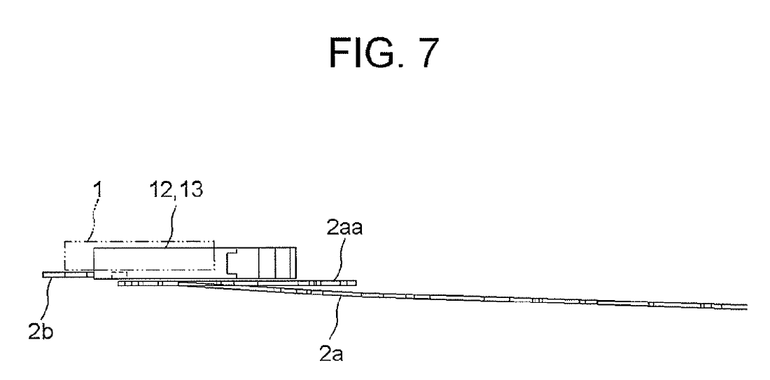

An embodiment of the present invention will be described with reference to FIGS. 2 to 7. FIG. 2 is a diagram showing the configuration of a hard disk drive, and FIG. 3 is a diagram showing the configuration of a head gimbal assembly. FIGS. 4A to 5B are diagrams showing the configuration of a microactuator for a magnetic head. FIGS. 6 and 7 are diagrams showing the configuration when the microactuator is mounted on a flexure.

[Configuration]

A hard disk drive 50 shown in FIG. 2 includes, in a casing 40, head gimbal assemblies 20 on each of which a magnetic head slider 1 for reading or writing data from/into a magnetic disk 30, which is a storage media, is mounted. Note that a plurality of magnetic disks 30 are provided therein, and a plurality of head gimbal assemblies 20 are stacked on the carriage corresponding to the magnetic disks 30 to thereby constitute a head stack assembly.

The head stack assembly is pivotally supported by a voice coil motor so as to be driven rotationally. By being driven rotationally by the voice coil motor, positioning control of the magnetic head slider 1 mounted at the tip part of each head gimbal assembly 20 is performed. Further, in the present invention, each head gimbal assembly 20 has a microactuator 10 (hereinafter referred to as an actuator) for a magnetic head, which holds the magnetic head slider 1 at the tip part thereof to thereby perform precise positioning control of the read/write element of the magnetic head slider 1. Hereinafter, the head gimbal assembly 20 and the actuator 10 will be explained in detail, particularly.

FIG. 3 shows the configuration of the head gimbal assembly 20 of the present invention. The head gimbal assembly 20 includes: the magnetic head slider 1; a flexure 2 having a spring property in which the magnetic head slider 1 is mounted on the tip part thereof; an FPC 3 (flexible printed circuit) which is formed on the flexure 2 and transmits signals to the magnetic head slider 1; and a load beam 4 supporting the flexure 2. The load beam 4 is to be mounted on a head arm via a base plate not shown.

Since the magnetic head slider 1 is mounted on the flexure 2 via the actuator 10 performing precise positioning as described above, the flexure 2 is formed in a shape enabling the magnetic head slider 1 and the actuator 10 to be mounted thereon. The configuration will be explained with reference to FIGS. 6 and 7. Note that FIGS. 6 and 7 only show the flexure 2 and the actuator 10. Although the FPC 3 is formed on the flexure 2, it is omitted in FIGS. 6 and 7.

The flexure 2 is mounted on the load beam 4, and consists of a flexure body 2a having a spring property in which a tongue plane 2aa is formed, and a separated part 2b separated from the flexure body 2a and connected by soldering with a terminal of the read/write element side (not shown) formed at the tip of the magnetic head slider 1 (left end part in FIG. 4). Note that the basic configuration of the flexure 2 is same as that of the conventional example.

Next, the configuration of the microactuator 10 for a magnetic head, which is a characteristic of the present invention, will be explained with reference to FIGS. 4A to 5B. FIG. 4A is a perspective view showing the configuration of the microactuator, and FIG. 4B is a front view thereof. Further, FIG. 5A is a perspective view showing the microactuator 10 on which the magnetic head slider is mounted, and FIG. 5B is a perspective view seen from the back side thereof.

The actuator 10 is formed in an almost U-shape including a base part 11 to be mounted on the tongue plane 2aa of the flexure 2 as described later, and a pair of arms 12 and 13, joined to the both ends, extending in the same direction. The base part 11 and the pair of arms 12 and 13 of the actuator 10 are formed integrally of a ceramic sintered body having elasticity as described later.

On the side faces of the respective arms 12 and 13, piezoelectric devices 12a and 13a such as PZT are mounted. These piezoelectric devices 12a and 13a are devices which expand or contract when a voltage is applied. Thereby, the elastic arms 12 and 13 will be deformed in a bending manner almost along the magnetic disk surface. With such a configuration, the pair of arms 12 and 13 will be deformed in a bending manner as described later, so it is possible to swing-drive the read/write element of the magnetic head slider 1 mounted between the tip parts thereof almost along the magnetic disk 30 surface. This enables precise positioning.

Further, the respective arms 12 and 13 have protrusions (support parts) 12b and 13b, opposite each other, protruding toward a space defined between the arms 12 and 13, formed on the bottom surfaces near the tip parts thereof. For example, the thickness of the protrusions 12b and 13b is 0.055 mm while the height of the arms 12 and 13 is 0.25 mm. On the top surfaces of the protrusions 12b and 13b, flat parts 12ba and 13ba are formed, to which an adhesive is applied. Further, to the inner side faces of the arms 12 and 13 near the parts on which the protrusions 12b and 13b are formed, the adhesive 14 is applied as in the case of conventional example.

In the almost U-shaped opening of the actuator 10 of the above-described configuration, that is, in the space defined between the pair of arms 12 and 13, the magnetic head slider 1 is accommodated and held by the arms 12 and 13. More specifically, as shown in FIGS. 5A and 5B, the bottom surface of the magnetic head slider 1 is placed on and supported by the flat parts of the protrusions 12b and 13b and fixed with an adhesive, and the both side faces of the magnetic head slider 1 are held between the arms 12 and 13 and fixed with the adhesive 14 applied to the side faces. Thereby, as shown in FIGS. 5A and 5B, the bottom face of the magnetic head slider 1 is supported by the protrusions 12b and 13b and the side faces thereof are held between the arms 12 and 13, so the magnetic head slider 1 is held stably.

Note that the shape and the forming positions of the protrusions 12b and 13b described above are just examples, so they are not limited to this configuration. For example, the protrusions 12b and 13b are non necessarily formed at positions near the tips of the arms 12 and 13, but may be formed at positions away from the tips. In particular, it is desirable that positions of the protrusions 12b and 13b be set appropriately corresponding to the mounting position of the magnetic head slider 1. For example, if the magnetic head slider 1 is fit within the arm length of the arms 12 and 13, that is, in the space defined by the arms 12 and 13, the protrusions 12b and 13b should be provided at positions for supporting the front side from the center (read/write element forming side) of the magnetic head slider 1. Further, if the magnetic head slider 1 protrudes from the arms 12 and 13 as described later, forming positions of the protrusions 12b and 13b are set while taking into account the arm length, stroke obtained therefrom and the anti-shock property. However, it is desirable that the protrusions 12b and 13b be formed on the tip parts of the arms 12 and 13 from the viewpoint of manufacturing or stroke.

Further, the thickness of the protrusions 12b and 13b along the height direction of the arm is preferably set corresponding to the height of the magnetic head slider 1. This is because there are various kinds of magnetic head sliders having different sizes such as a pico slider, a femto slider and a slider of the intermediate size, and depending on the thickness, the distance between the read/write element of the magnetic head slider 1 when mounted on the actuator 10 and the magnetic disk surface changes. Accordingly, it is desirable to set the height (length along the height direction of the arms 12 and 13) of the protrusions 12b and 13b supporting the surface opposite to the ABS of the magnetic head slider 1 by adjusting it so as to set the distance between the magnetic head slider 1 and the magnetic disk surface properly.

Further, parts of the protrusions 12b and 13b, where the magnetic head slider 1 contacts, are not necessarily flat. Moreover, although it has been described that an adhesive is applied to the flat parts 12ba and 13ba of the protrusions 12b and 13b, it is not necessary to apply the adhesive, and a state of contacting the magnetic head slider 1, not being fixed, is also acceptable.

[Mounting Method]

Next, a method of mounting the magnetic head slider 1 on the actuator 10 described above will be explained, and further, a method of manufacturing the head gimbal assembly 20 by such a method will be described. Note that since the present invention is characterized in the procedures of mounting the magnetic head slider 1 on the actuator 10, a step of mounting the actuator 10 on the flexure can be performed by any procedure.

First, the magnetic head slider 1 is accommodated between the arms 12 and 13 of the actuator 10, and is placed on the flat parts 12ba and 13ba of the protrusions 12b and 13b. At this time, right and left positions and front and back positions of the magnetic head slider 1 are adjusted so as to carry out positioning for mounting. In the present embodiment, an end face (tip part) of the read/write element side of the magnetic head slider 1 is arranged to protrude from the tip side (one end side) of the arms 12 and 13, as shown in FIGS. 5A to 7. Then, the magnetic head slider 1 is held between the pair of arms 12 and 13 and the adhesive applied to the protrusions 12b and 13 and the adhesive 14 applied to the inner faces of the arms 12 and 13 are hardened. Thereby, the magnetic head slider 1 is mounted on the actuator 10.

Then, as shown in FIG. 6, the base part 11 of the actuator is placed on the back end part of the tongue plane 2aa of the flexure 2, and fixed with an adhesive or the like. Further, as shown in FIG. 7, position of the separated part 2b of the flexure 2 is also set. At this time, the positions of the read/write element side terminal of the magnetic head slider 1 held by the actuator 10 and the trace side terminal of the separated part 2b are adjusted so as to have a distance capable of being joined by soldering. Since the FPC 3 is formed on the flexure 2 (not shown in FIGS. 6 and 7, see FIG. 3), the flexure body 2a and the separated part 2b are formed integrally. Further, since the FPC 3 has elasticity, it is possible to flexibly cope with positional adjustment of the separated part 2b described above.

Then, piezoelectric element side terminals (not shown) formed on the side faces of the arms 12 and 13 of the actuator 10 and the trace side terminal formed on the tongue plane 2aa are connected by metal bonding or the like. Thereby, a driving voltage is applied to the piezoelectric elements 12a and 13a via the FPC 3, whereby they expand or contract. As a result, the arms 12 and 13 are deformed in a bending manner. Further, the read/write element side terminal of the magnetic head slider 1 and the terminal of the separated part 2b are connected by soldering.

Although the case where the magnetic head slider 1 is mounted on the actuator 10 and then mounted on the flexure 2 has been exemplary shown in the above description, it is also acceptable that only the actuator 10 is mounted on the flexure 2 first, and then the magnetic head slider 1 is mounted on the actuator 10 according to the procedures described above.

Through the procedures, positioning of the magnetic head slider 1 with respect to the microactuator 10 at the time of mounting becomes easy, which enables to simplify the manufacturing process. Further, since the assembling dimensional accuracy at the time of mounting is improved, is possible to realize highly accurate positioning operation of the magnetic head slider even at the time of reading or writing. Further, since the anti-hock property is improved in the thickness direction with respect to the magnetic head slider 1, reliability can be improved. Moreover, since only such an easy improvement as to provide the protrusions 12ba and 13ba to the arms 12 and 13 is performed to the actuator 10, the manufacturing cost can be reduced.

In particular, in the present embodiment, the protrusions 12b and 13b are formed on the tip parts of the arms 12 and 13, so the magnetic head element side of the magnetic head slider 1 can be supported. This enables more stable support, whereby the accuracy in reading and writing can be improved.

Further, since a part nearer to the center of gravity of the magnetic head slider 1 can be supported by protruding the magnetic head slider 1 from the tips of the arms 32 and 13 as described above, further stable support can be realized. Moreover, the swing range of the read/write element positioned at the tip of the slider 1, caused due to bending deformation of the arms 12 and 13, can be set wide. However, in the present invention, the magnetic head slider 1 is not limited to be mounted so as to protrude from the tips of the arms 12 and 13 of the actuator 10. Corresponding to it, the forming positions of the protrusions 12b and 13b can be altered as described above.

### Embodiment 2

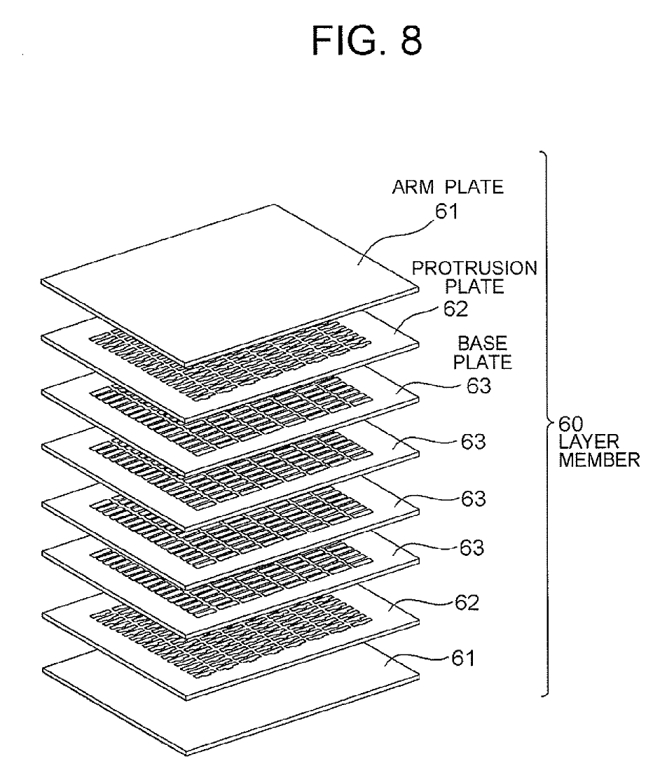

Next, a second embodiment of the present invention will be described. In the present embodiment, a method of manufacturing the actuator 10 will be described with reference to FIGS. 8 to 14. FIGS. 8 to 13 are diagrams illustrating the manufacturing process of the actuator 10, and FIG. 14 is a flowchart explaining the manufacturing procedures.

Firstly, as shown in FIG. 8, plates having prescribed thicknesses, constituting the respective parts of the actuator 10, are prepared. More specifically, a pair of (two) arm planes 61 forming a pair of arms 12 and 13, four base plates 63 forming the base part 11, and two protrusion plates 62 (support part plates) for forming the protrusions 12b and 13b are prepared. Then, as shown in FIG. 8, they are stacked in the order of the arm plate 61, the protrusion plate 62, four base plates 63, the protrusion plate 62 and the arm plate 61, from the top to the bottom, to thereby constitute a layer member 60 (stacking step, step S1 in FIG. 14). In other words, the four base plates 63 are interposed between the pair of arm plates 61, and the protrusion plates 62 are inserted in between the arm plate 61 and the base plate 63 at the top and in between she arm plate 61 and the base plate 63 at the bottom respectively, whereby they are stacked.

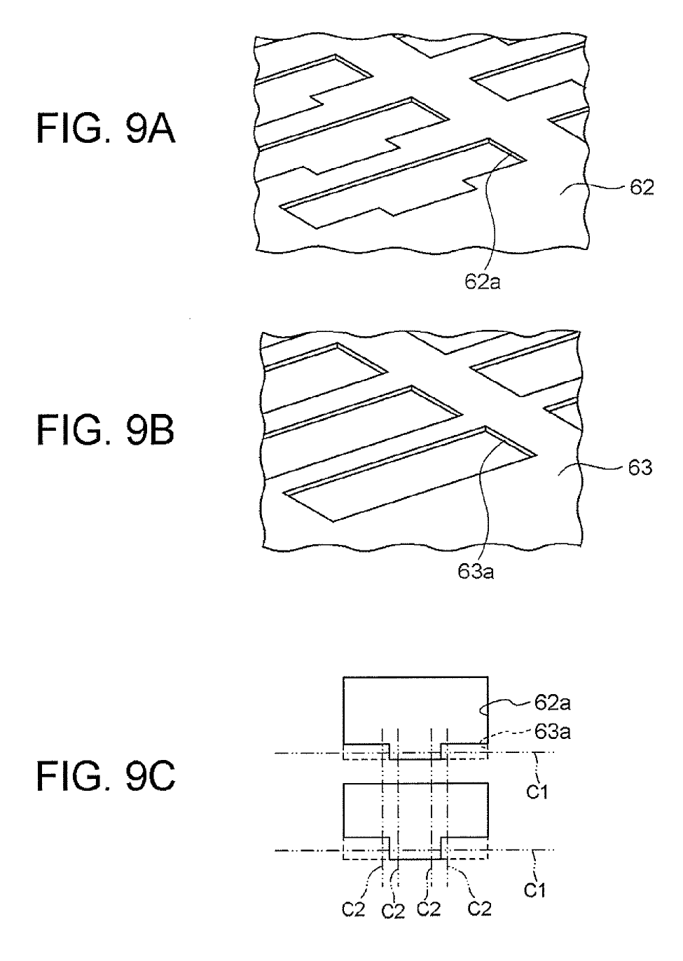

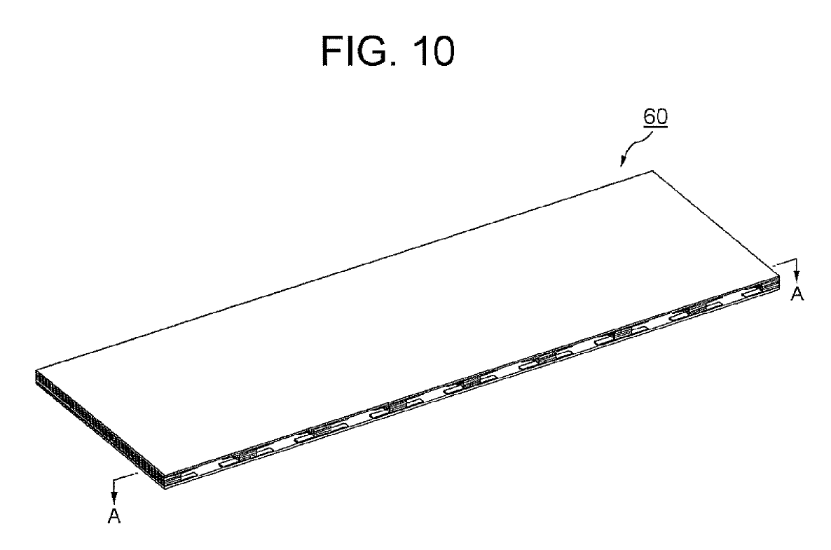

The protrusion plates 62 and the base plates 63 have cutouts of different shapes, respectively. That is, the protrusion plate 62 is provided with a cutout 62a in a convex shape such that the center of one long side of the rectangle protrudes as shown in FIG. 9A, and the base plate 63 has a rectangle cutout 63a as shown in FIG. 9B. The cutouts 62a and 63a of the plates 62 and 63 are formed to have almost same heights and widths, so the cutout 62a of the protrusion plate 62 is formed to be smaller by the right and left areas of the protruding part. When stacked, they are arranged such that the positions of the cutouts 62a and 63a coincide. This state is shown in FIG. 9C. FIG. 9C is a top view in which the arm plate 61 positioned at the top layer is excluded. As shown in FIG. 9C, the cutouts 62a and 63a are arranged such that the respective long sides are aligned, so their positions are arranged to coincide with each other substantially. Nose that the plates 61, 62 and 63 are made of ceramic members. FIG. 10 shows the configuration of she layer member 60 of this stage.

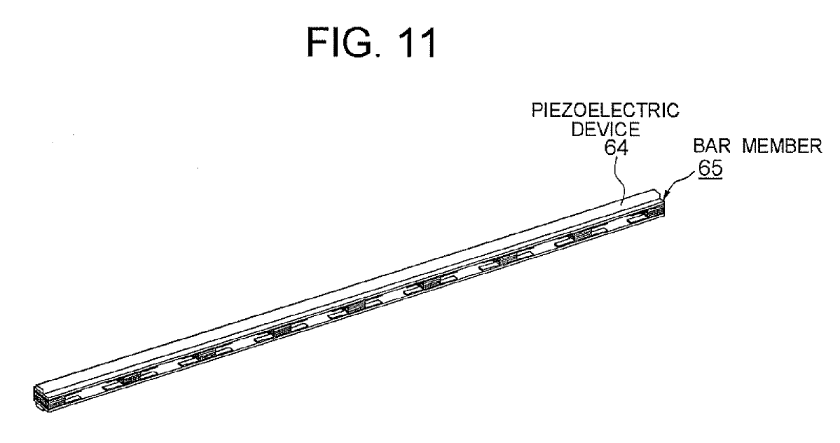

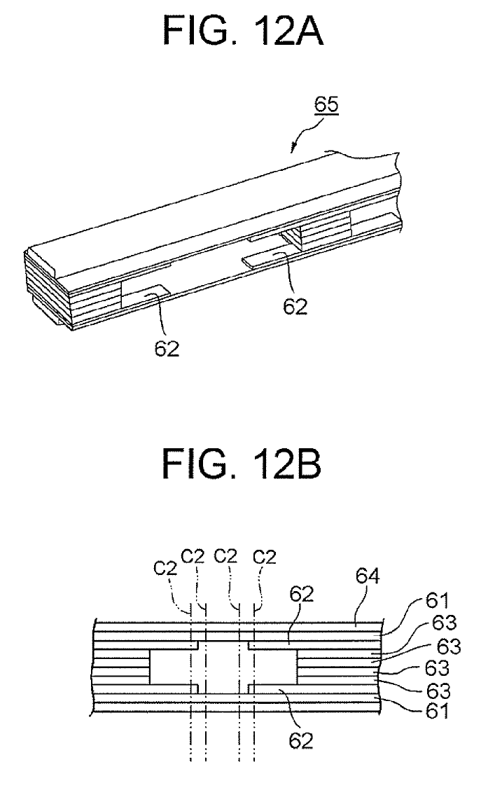

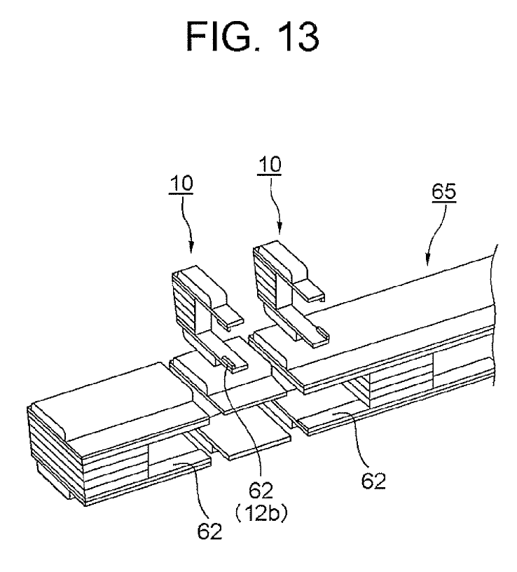

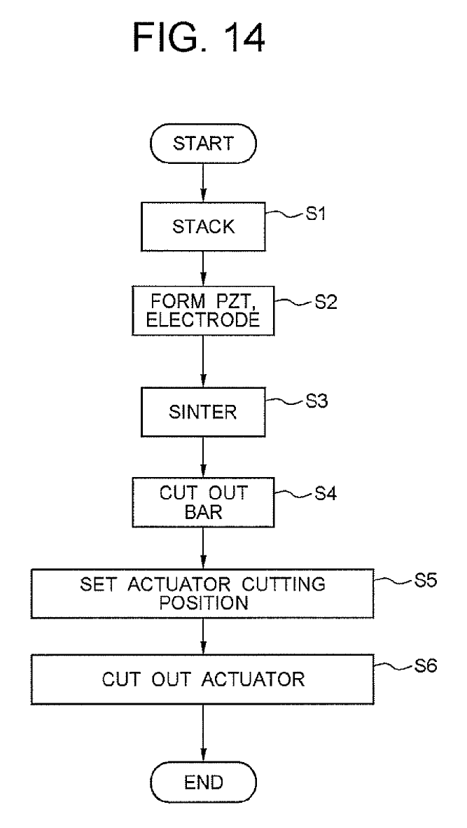

Next, the layer member 60 is pre-dried, and the piezoelectric devices 64 and electrodes are formed by printing on the outer surfaces of the arm plates 61 at the top layer and the bottom layer (PZT device forming step, stop S2 in FIG. 14). Although not shown in FIG. 10, the piezoelectric device 64 is formed in a band shape corresponding to the shape cut into a bar (bar member 65) as shown in FIG. 11 described later.

Then, the layer member 60 is sintered in the state of being compression-layered to thereby be formed as a wafer (step S3 in FIG. 14). Then, it is cut along the line A-A in FIG. 10, whereby a bar member 65 is cut out (step S4 in FIG. 14). FIG. 11 shows the configuration of the bar member 65 of this stage. Note that the piezoelectric devices 64 and electrodes may be formed on the arm plates 61 after cut into the bar member 65, or may be formed on the arm plates 61 before stacked.

When cutting out the bar member 65, cutting is performed along a cut line C1 shown in FIG. 9C More specifically, the cut line C1 is set across the protruding part of the cutout 62a of the protrusion plate 62. Thereby, in the area near the cut part of the cut-out bar member 65, the right and left parts of the protruding part remain in band shapes. FIG. 12A is an enlarged view of the cut part of the bar member 65.

Next, cut lines for cutting out the microactuator 10 from the bar member 65 are set (step S5 in FIG. 14). Then, the microactuator 10 is cut out along the cut lines C2 shown in FIG. 12B (cutting step, step S6 in FIG. 14). Now, the cut lines C2 will be described. The cut lines C2 are set along the stacking direction of the layer member 60. In other words, they are set perpendicular to the plate surfaces of the respective plates 61 to 63. The cut positions are set such that end parts of the protrusion plates 62 are included in the actuator 10 to be cut cut. Thereby, in the actuator 10, the protrusions 12b and 13b are formed near the tip parts of the arms 12 and 13.

Note that the protruding amounts of the protrusions 12b and 13b of the cut-out actuator 10 correspond to the thickness of the protrusion plates 62. Accordingly, in order to set the protruding amount to a desired length, it is only necessary to use protrusion plates 62 having an appropriate thickness. Further, the height of the protrusions 12h and 13b, that is, the height along the height direction of the arms 12 and 13 correspond to the cutout amount of the protrusion plates 62. Therefore, in order to set the height to a desired height, it is only necessary to set the positions of the cut lines C2 properly.

### INDUSTRIAL APPLICABILITY

The microactuator, which is the present invention, can be used as an actuator for position-driving a magnetic head slider to be mounted on a hard disk drive, and has industrial applicability.

What is claimed is:

1. A microactuator comprising:
a base part to be joined no a flexure;
a pair of arms, joined to the base part, for holding a magnetic head slider therebetween; and
a PZT device, mounted on each of the arms, to be deformed in an expanding or contracting manner based on a drive signal applied, wherein
each of the arms is provided with a support part for supporting a surface opposite to an ABS forming surface of the magnetic head slider.

2. The microactuator as claimed in claim 1, wherein the support part is formed as a protrusion protruding from each of the arms.

3. The microactuator as claimed in claim 1, wherein the support part has a flat part for supporting the magnetic head slider.

4. The microactuator as claimed in claim 1, wherein the support part is provided near a tip part of the arm on a side opposite to the base part.

5. A head gimbal assembly comprising:
a suspension having a flexure;
the microactuator according to claim 1 to be joined to the flexure; and
a magnetic head slider supported by the support part of the microactuator and held between the pair of arms.

6. The head gimbal assembly as claimed in claim 5, wherein the support part of the microactuator is applied with an adhesive for fixing the magnetic head slider.

7. The head gimbal assembly as claimed in claim 5, wherein the magnetic head slider is mounted so as to protrude from tip parts of the arms of the microactuator.

8. A hard disk drive on which the head gimbal assembly according to claim 5 is mounted.

9. A method of manufacturing the head gimbal assembly according to claims 5, comprising the steps of:
placing and positioning a magnetic head slider on the support part of the microactuator; and
holding the magnetic head slider between the pair of arms.

10. A method of manufacturing a microactuator, comprising the steps of:
stacking one or more base plates constituting a base part to be mounted on a flexure of a head gimbal assembly by inserting the base plates in between a pair of arm plates constituting a pair of arms joined to the base part;
before or aster the step of stacking, forming a PZT device, mounted on each of the arms, to be deformed in an expanding or contracting manner based on a drive signal applied, on an outer surface of each of the arm plates; and
cutting a layer member layered in the step of stacking along a stacking direction so as to cut out a microactuator holding side faces of a magnetic head slider between the pair of arms, wherein
in the step of stacking, a support part plate forming a support part for supporting a flat surface perpendicular to a thickness direction of the magnetic head slider held between the arms, is inserted between the arm plate and the base plate.

11. The method of manufacturing a microactuator as claimed in claim 10 wherein in the step of cutting, a height of the support part along a height direction of the arm is set, and then the microactuator is cut out.

12. A method of manufacturing the microactuator according to claim 1, comprising the steps of:
stacking one or more base plates constituting a base part to be mounted on a flexure of a head gimbal assembly by inserting the base plates in between a pair of arm plates constituting a pair of arms joined to the base part;
before or after the step of stacking, forming a PZT device, mounted on each of the arms, to be deformed in an expanding or contracting manner based on a drive signal applied, on an outer surface of each of the arm plates; and
cutting a layer member layered in the step of stacking along a stacking direction so as to cut out a microactuator holding side faces of a magnetic head slider between the pair of arms, wherein
in the step of stacking, a support part plate forming a support part for supporting a flat surface perpendicular to a thickness direction of the magnetic head slider held between the arms, is inserted between the arm plate and the base plate.
